(19) United States
(12) Patent Application Publication
(10) Pub. No.: US 2026/0111699 A1
(43) Pub. Date: Apr. 23, 2026

(54) CARD WITH MAGNET ARRAY

(71) Applicant: Visa International Service Association, San Francisco, CA (US)

(72) Inventor: Yuexi Chen, Foster City, CA (US)

(73) Assignee: Visa International Service Association, San Francisco, CA (US)

(21) Appl. No.: 19/117,748

(22) PCT Filed: Oct. 7, 2022
(86) PCT No.: PCT/US2022/077790

§ 371 Date: Apr. 2, 2025

(51) Int. Cl. G06K 19/077; G06K 19/07; H01F 7/02

(52) U.S. Cl. CPC G06K 19/07743; G06K 19/0707; G06K 19/0723; H01F 7/0252

(57) ABSTRACT

The present disclosure provides various cards (e.g., payment cards, identification cards, driver's license cards) that are removably attachable to a portable electronic device. In some aspects, the portable electronic device may include a charging coil, a ferromagnetic component disposed about the charging coil, and a ferromagnetic alignment component. The card can include a substrate and a magnet embedded the substrate. The magnet can magnetically couple to the ferromagnetic component disposed about the charging coil.

### TECHNICAL FIELD

At least some aspects of the present disclosure relate to cards (e.g. payment cards, identification cards, driver's license cards, access cards, etc.), such as cards that are removably attachable to a portable electronic device.

### BACKGROUND

The use of portable electronic devices is ever increasing in ubiquity. For example, users often have their smartphones with them whenever they leave their home. As a result, attachable accessories such as protective cases, wallets, and gripping devices have been developed to provide smartphones and other portable electronic devices with additional functionality. In some aspects, these attachable accessories aim to provide a convenient means to hold and store items that users frequently carry in addition to their portable electronic devices.

One such item that users frequently carry are payment cards (e.g., credit cards, debit cards, etc.). Like smartphones, users often have a payment card with them whenever they leave their home. Accordingly, various attachable accessories for portable electronic devices have been developed to hold and store payment cards. However, despite their intended convenience, these attachable accessories can have many drawbacks. For example, attachable wallet accessories can be bulky and add unwanted thickness to smartphones. Thus, using an attachable wallet accessory can make it difficult to fit a smartphone inside a user's pocket and can potentially detract from the smartphone's aesthetic appearance. Moreover, attachable wallet accessories often utilize tight storage compartments rendering it difficult for users to easily locate and remove their payment card. This can be especially problematic, for example, when the user is at a merchant's checkout counter and would like to quickly provide payment. Furthermore, attachable case and wallet accessories are often either expensive or poorly constructed.

Accordingly, there is a need for devices and methods that can allow users to carry a card (e.g., a payment card) along with their portable electronic device without the various drawbacks related to attachable accessories described above. The present disclosure provides solutions utilizing a card that is removably attachable to a portable electronic device.

### SUMMARY

In one aspect, the present disclosure provides a card removably attachable to a portable electronic device. The portable electronic device includes a charging coil, a ferromagnetic component disposed about the charging coil, and a ferromagnetic alignment component. The card includes a substrate and a magnet. The magnet is embedded in the substrate to magnetically couple to the ferromagnetic component disposed about the charging coil.

In one aspect, the present disclosure provides a card removably attachable to a portable electronic device. The portable electronic device includes a charging coil, a ferromagnetic component disposed about the charging coil, and a ferromagnetic alignment component. The card includes a card body and a magnet. The card body includes a first printed layer, a second printed layer, and a core layer between the first printed layer and the second printed layer. The magnet is embedded in the card body to magnetically couple to the ferromagnetic component disposed about the charging coil.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, together with the detailed description below, are incorporated in and form part of the specification, and serve to further illustrate aspects of concepts that include the claimed disclosure and explain various principles and advantages of those aspects.

The apparatuses and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIGS. 1A-1B are perspective views illustrating a payment card removably attaching to a portable electronic device, according to at least one aspect of the present disclosure.

FIG. 2 illustrates a simplified representation of a wireless charging system incorporating a ferromagnetic component disposed about a charging coil, according to at least one aspect of the present disclosure.

FIG. 3 illustrates a portable electronic device including various components of a wireless charging system, according to at least one aspect of the present disclosure.

FIG. 4 illustrates a payment card that is removably attachable to the portable electronic device of FIG. 3, according to at least one aspect of the present disclosure.

FIGS. 5A-5B illustrate a payment card aligning relative to a portable electronic device using an alignment magnet, according to at least one aspect of the present disclosure.

FIGS. 6A-6D illustrate payment cards with various magnet arrays, according to several aspects of the present disclosure.

FIG. 7A-7B illustrate exploded views of various payment cards including multiple layers, according to several aspects of the present disclosure.

FIG. 8A-8C illustrate cross-sectional views of various magnet embedding configurations, according to several aspects of the present disclosure.

Corresponding reference characters indicate corresponding parts throughout the several views. The exemplifications set out herein illustrate various aspects of the present disclosure, in one form, and such exemplifications are not to be construed as limiting the scope of the disclosure in any manner.

### DESCRIPTION

Before explaining various forms of the payment card, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof. Also in the following description, it is to be understood that terms such as “forward,” “rearward,” “left,” “right,” “above,” “below,” “upwardly,” “downwardly,” and the like are words of convenience and are not to be construed as limiting terms.

A “payment card” can refer to any device that may be used to conduct a transaction, such as a financial transaction. For example, a payment card may be used to provide payment information to a merchant. A payment card can include a substrate such as a paper, metal, or plastic card, and information that is printed, embossed, encoded, and/or otherwise included at or near a surface of the payment card. A payment card can be hand-held and compact so that it can fit into a consumer's wallet and/or pocket (e.g., pocket-sized). A payment card can be a smart card, a debit device (e.g., a debit card), a credit device (e.g., a credit card), a stored value device (e.g., a stored value card or “prepaid” card), a magnetic stripe or chip card. A payment card may operate in a contact and/or contactless mode. For example, a payment card may be an electronic payment device, such as a smart card, a chip card, an integrated circuit card, and/or a near field communications (NFC) card, among others. An electronic payment device may include an embedded integrated circuit and the embedded integrated circuit may include a data storage medium (e.g., volatile and/or non-volatile memory) to store information associated with the electronic payment device, such as an account identifier and/or a name of an account holder. A payment card may interface with an access device such as a point-of-sale device to initiate the transaction.

A “card” can refer to a payment card, a security card, an access card, a memory card, a driver license card, a loyalty card, a membership card, an insurance card, a passport card, and/or an identification card, or any other type of card that a user may carry. Any of the various aspects disclosed herein with respect to a payment card can be similarly applied to other types of cards.

An “access device” may refer to a device that receives information from a payment card to initiate a transaction. For example, an access device may be a point-of-sale device configured to read account data encoded in a magnetic stripe or chip of a payment card. Other examples of access devices include cellular phones, personal computers, tablets, handheld specialized readers, set-top boxes, electronic cash registers, automated teller machines (ATMs), virtual cash registers, kiosks, security systems, access systems, and the like. Access devices may use means to interact with a payment card, such as NFC, radio frequency (RF), optical readers, and/or magnetic stripe readers.

As used herein, a “portable electronic device” may refer to any electronic device that is portable and operated by user. Examples of portable electronic devices include smartphones and other mobile phones (e.g., cellular phones), tablet computers, laptop computers, netbooks, personal music players, e-readers, hand-held specialized readers, mobile Wi-Fi devices, handheld gaming systems, navigation systems, storage devices, portable media players, wearable devices (e.g., fitness bands, smart watches, headphones, earbuds), various electronic devices included in automobiles, and any other electronic device that a user may transport, carry, and/or wear. Other portable electronic devices can include robotic devices, remote-controlled devices, personal-care appliances, and so on.

As described above, the use of both portable electronic devices and payment cards is seemingly ubiquitous. Users often carry a smartphone and a payment card with them whenever they leave their home. Accessories that are attachable to portable electronic devices (e.g., attachable cases, attachable wallets) have been developed in an attempt to provide a convenient means to hold and store payment cards so that portable electronic devices and payment cards can be easily carried together.

However, using attachable accessories such as attachable cases and wallets can have numerous drawbacks. For example, attachable wallets can be bulky and add unwanted thickness making it difficult for users to fit their portable electronic device inside their pocket. Also, attachable wallets may utilize tight compartments for holding and storing payment cards. These tight compartments can make it difficult for users to locate and/or remove a desired payment card. Moreover, attachable cases and wallets are often either expensive or poorly constructed. In addition, such accessories add weight to the portable electronic devices beyond the weight of the payment cards carried by the accessories. The additional weight deducts from the portability of the portable electronic devices. Accordingly, there is a need for alternate devices and methods that allow users to easily carry a card (e.g., a payment card) along with their portable electronic device.

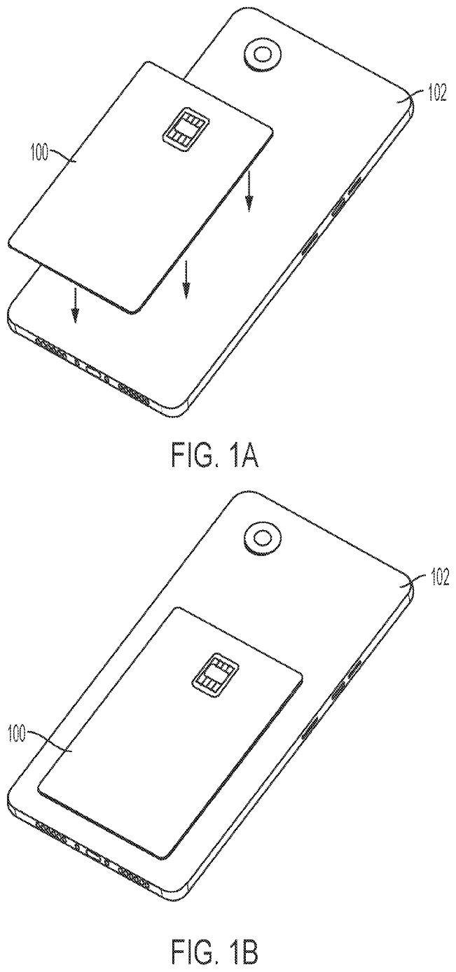

The present disclosure provides various cards (e.g., payment cards, identification cards, access cards, driver's license cards, etc.) that are removably attachable to a portable electronic device. In some aspects, the cards disclosed herein are removably attachable to a portable electronic device via magnetic coupling. For example, FIGS. 1A-1B illustrate an example of a payment card 100 removably attaching to a portable electronic device 102. As explained in more detail below, the payment card 100 can include one or more than one magnet that is configured to magnetically couple to a ferromagnetic component of the portable electronic device 102. Positioning the payment card 100 proximately to the portable electronic device 102 (as shown in FIG. 1A) can cause the payment card 100 to removably attach to a surface of the portable electronic device 102 (as shown in FIG. 1B).

The cards disclosed herein can provide numerous benefits. For example, as shown in FIGS. 1A-1B, the payment card 100 can be directly attached to the portable electronic device 102 without the use of an accessory such as an attachable card holder, case, or wallet. Accordingly, users can avoid the previously-discussed issues related to the attachable accessories. Moreover, the magnetic coupling force between the payment card 100 and the portable electronic device 102 can be optimized: (i) to allow an intended detachment of the payment card 100 from the portable electronic device 102, and (ii) to prevent/resist an unintended detachment of the payment card 100 (e.g., when the portable device 102 is slid into or out of a user's pocket). This can allow the payment card 100 to be quickly and easily accessed by a user for providing payment to a merchant, for example.

As another example, the payment card 100 may add only a relatively minimal thickness (e.g., no greater than 0.76 mm) when removably attached to the portable electronic device 102. Accordingly, the portable electronic device 102 and the payment card 100 can be more easily stored by a user (e.g., in the user's pocket) compared to a portable electronic device 102 that is attached to a card holder, case, or wallet accessory. Moreover, the minimal thickness of the payment card 100 and/or other aesthetic designs included on a surface of the payment card 100 can minimally detract from or even enhance the aesthetic appearance of the portable electronic device 102.

As yet another example, the payment card 100 would encourage users to conduct more financial transactions using the payment card 100. This can provide business-related benefits to a supplier of the payment card 100 and/or a financial institution associated with the payment card 100. For example, as discussed above, users frequently carry their portable electronic devices with them whenever they leave their home. Enabling the payment card 100 to removably attach to the portable electronic device 102 would encourage users to also bring the payment card 100 with them anytime they carry their portable electronic device 102, even in situations where users might have otherwise decided not to bring a payment card. Furthermore, as shown in FIG. 1B, the payment card 100 is clearly visible when removably attached to the portable electronic device 102. Accordingly, users of the portable electronic device 102 may be frequently reminded of the payment card 100 and therefore may be more likely to conduct a transaction using the payment card 100.

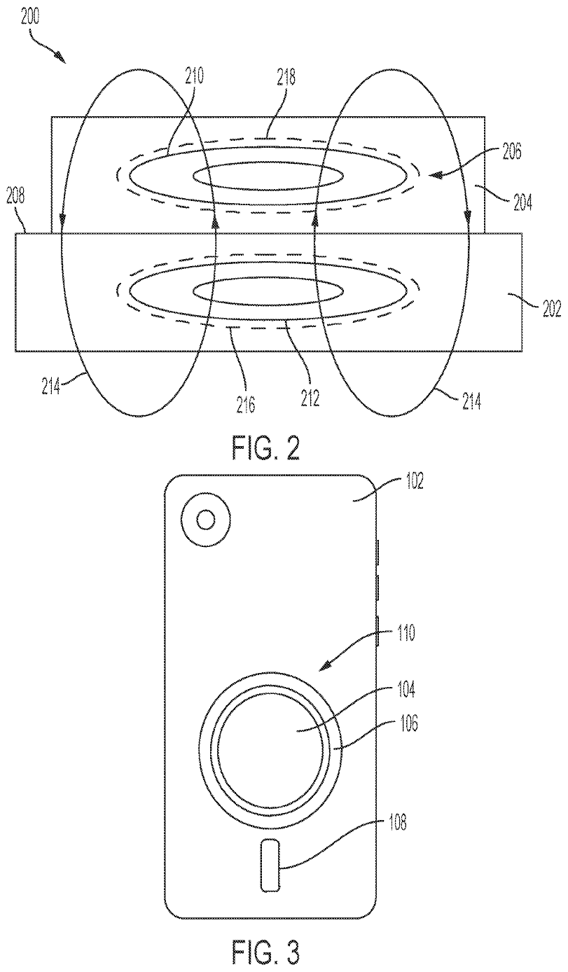

As noted above, the payment card 100 can include one or more than one magnet that is configured to magnetically couple to a ferromagnetic component included in the portable electronic device 102. The ferromagnetic component included in the portable electronic device 102 may be part of a wireless charging system, for example. Accordingly, in some aspects, the present disclosure provides various payment cards that include a magnet configured to couple to a ferromagnetic component of a portable electronic device's wireless charging system. FIGS. 2-3 and the accompanying description below provide examples of wireless charging systems in portable electronic devices. Following these examples, the disclosure provides details related to various payment cards that are removably attachable to portable electronic devices.

FIG. 2 illustrates a simplified representation of a wireless charging system 200 including a portable electronic device 204 and a wireless charging device 202. The portable electronic device 204 is positioned on a charging surface 208 of the wireless charging device 202. The wireless charging device 202 can be any device that is configured to generate time-varying magnetic flux to induce a current in a suitably configured receiving device.

The portable electronic device 204 includes a charging coil 210 and the wireless charging device 202 includes a charging coil 212 (e.g., inductive charging coils 210 and 212). To enable wireless power transfer, the charging coils 210 and 212 can operate to transfer power therebetween. For example, the charging coil 212 can be a transmitter coil that generates a time-varying magnetic flux 214 and the charging coil 210 can be a receiver coil in which an electric current is induced in response to the time-varying magnetic flux 214. The received electric current can be used to charge a battery of the portable electronic device 204, to provide operating power to a component of the portable electronic device 204, and/or for other purposes as desired.

To enable efficient wireless power transfer, it is desirable to align the charging coils 212 and 210. In some aspects, a magnetic alignment system 206 can provide such alignment. In the example shown in FIG. 2, the magnetic alignment system 206 includes a ferromagnetic component 218 disposed within or on a surface of the portable electronic device 204 and a ferromagnetic component 216 disposed within or on a surface of the wireless charging device 202. The ferromagnetic components 216 and 218 are configured to magnetically attract one another into an aligned position that causes the charging coils 210 and 212 to be aligned.

In various aspects, the ferromagnetic component 216 and/or the ferromagnetic component 218 can be formed of one or more than one magnet, such as arcuate magnets arranged in an annular configuration (e.g., an array of arcuate magnets arranged in an annular configuration). In some aspects, each of the arcuate magnets can have its magnetic polarity oriented in a desired direction so that magnetic attraction between the ferromagnetic component 216 and the ferromagnetic component 218 provides a desired alignment. In some aspects, the ferromagnetic component 216 and/or the ferromagnetic component 218 can include one or more than one magnet that includes a first magnetic region with a magnetic polarity oriented in a first direction and a second magnetic region with a magnetic polarity oriented in a second direction different from (e.g., opposite to) the first direction.

FIG. 3 illustrates a portable electronic device 102 that includes a wireless charging system 110, according to at least one aspect of the present disclosure. In some aspects, the wireless charging system 110 is encased within an outer housing of the portable electronic device 102 and therefore may not be visible when looking at the assembled portable electronic device 102. For illustrative purposes, FIG. 3 shows the position of the wireless charging system 110 within the portable electronic device 102. The wireless charging system 110 includes a charging coil 104 and a ferromagnetic component 106 disposed about the charging coil 104. The electronic device 102 can be similar in many respects to the portable electronic device 204 of FIG. 2. For example, the charging coil 104 can be similar to the charging coil 210 and the ferromagnetic component 106 can be similar to the ferromagnetic component 218. In some aspects, the wireless charging system 110 can further include a ferromagnetic alignment component 108 that is configured to rotationally align the portable electronic device 102 relative to a wireless charging device (e.g., after the charging coil 104 is concentrically aligned with a charging coil of the wireless charging device by the ferromagnetic component 106). For example, the ferromagnetic alignment component 108 may act to ensure that the elongated edges of the portable electronic device 102 are rotationally oriented in a desired position with respect to a wireless charging device.

Although FIG. 3 depicts the ferromagnetic alignment component 108 and the ferromagnetic component 106 in a specific configuration (e.g., a strip of ferromagnetic material disposed proximately to a ring of ferromagnetic material that surrounds the charging coil 104), the wireless charging system 110 may include various other configurations of the ferromagnetic alignment component 108 and the ferromagnetic component 106. For example, the ferromagnetic component 106 can include an array of multiple ferromagnetic components disposed about the charging coil 104, for example, in a linear configuration, a polygonal configuration (e.g., a polygon with 3, 4, 5, 6, 7, 8, or more than 8 sides), or a ring configuration. As another example, the ferromagnetic alignment component 108 may include an array of multiple ferromagnetic components positioned relative to the ferromagnetic component 106, for example, in a linear configuration, a polygonal configuration (e.g., a polygon with 3, 4, 5, 6, 7, 8, or more than 8 sides), or a ring configuration. As yet another example, the ferromagnetic alignment component 108 may be omitted from the wireless charging system 110.

Having described illustrative examples of various portable electronic devices, wireless charging systems, and ferromagnetic components included in the portable electronic devices and/or the wireless charging systems, the disclosure now turns to various cards (e.g., payment cards) that are removably attachable to portable electronic devices.

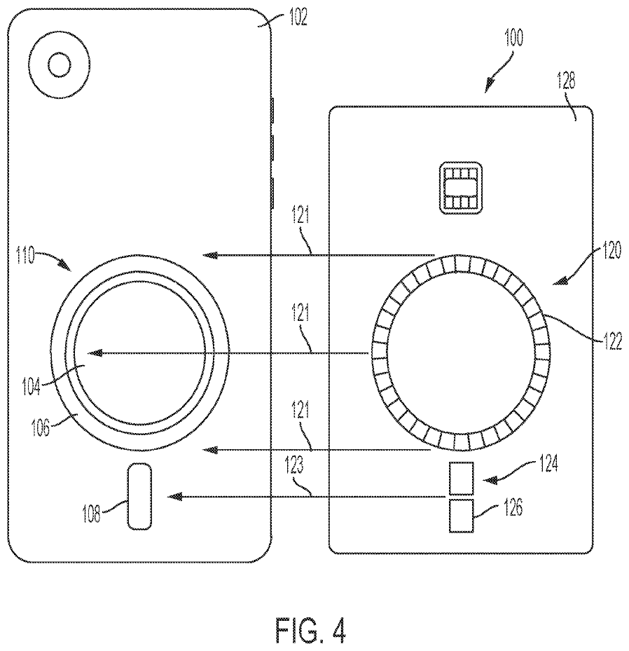

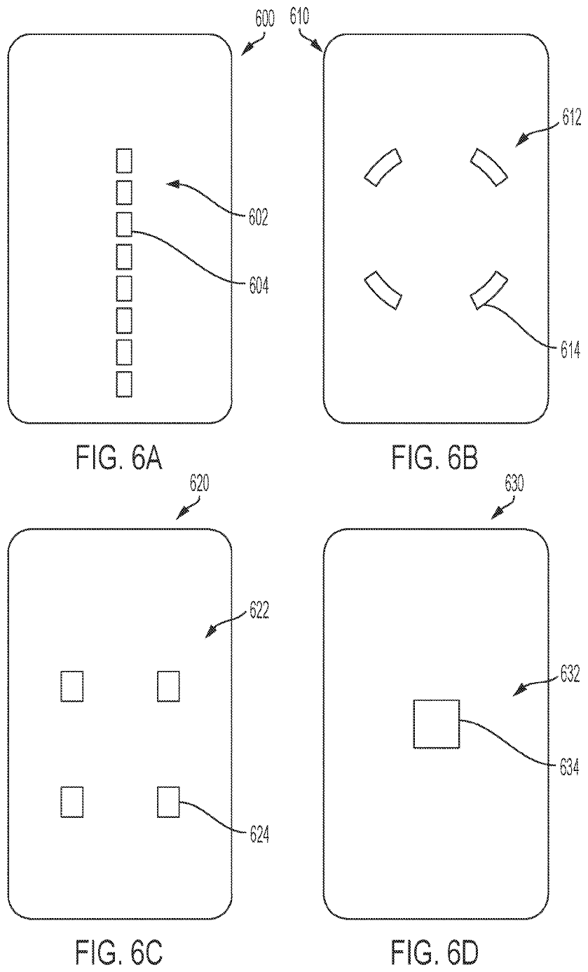

FIG. 4 illustrates a payment card 100 that is removably attachable to the portable electronic device 102 of FIG. 3, according to at least one aspect of the present disclosure. The payment card 100 includes a substrate 128 and a magnet 122 supported by the substrate 128. The magnet 122 is configured to magnetically couple to the ferromagnetic component 106 of the portable electronic device 102. In the non-limiting aspect of FIG. 4, the payment card 100 includes multiple magnets 122 forming a magnet array 120 and defining a ring that complements the ring configuration of the ferromagnetic component 106. In other aspects, the payment card 100 can include other magnet 122 and/or magnet array 120 configurations. For example, the payment card 100 can include any of the magnet and/or magnet array configurations described in detail below with respect to FIGS. 6A-6D, such as a linear configuration, a polygonal configuration (e.g., a polygon with 3, 4, 5, 6, 7, 8, or more than 8 sides), a ring configuration, or any other suitable configuration that defines a profile that complements a ferromagnetic component included in a portable electronic device.

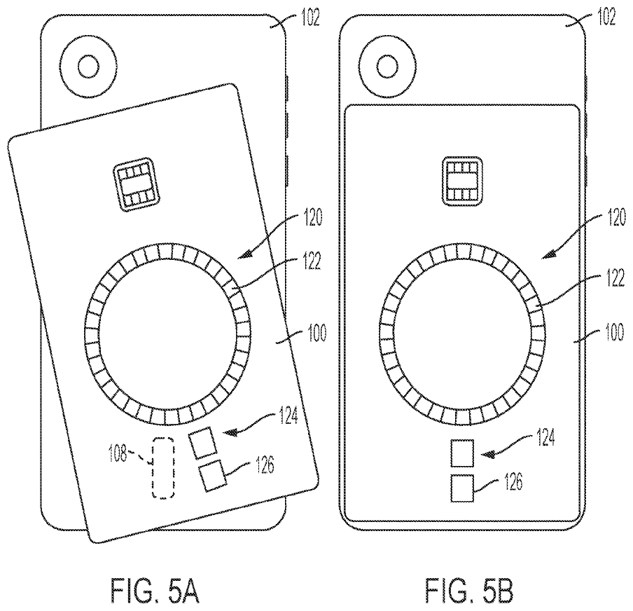

In various aspects, the payment card 100 can include an alignment magnet 126 supported by the substrate 128. The alignment magnet 126 is configured to magnetically couple to the ferromagnetic alignment component 108 of the portable electronic device 102 to align the payment card 100 relative to the portable electronic device 102, for example, as described in detail below with respect to FIGS. 5A-5B. In the non-limiting aspect of FIG. 4, the payment card 100 includes multiple alignment magnets 126 forming an alignment magnet array 124. In other aspects, the payment card 100 can include other alignment magnet 126 and/or alignment magnet array 124 configurations. For example, the alignment magnet(s) 126 and/or the alignment magnet array 124 can be configured to define a profile that complements any of the various ferromagnetic alignment component 108 configurations that may be used in the portable electronic device 102. Accordingly, the alignment magnet(s) 126 and/or the alignment magnet array 124 can define, for example, a linear configuration, a polygonal configuration (e.g., a polygon with 3, 4, 5, 6, 7, 8, or more than 8 sides), a ring configuration, or any other suitable configuration. In yet other aspects, the alignment magnet(s) 126 and/or the alignment magnet array 124 may be omitted from the payment card 100.

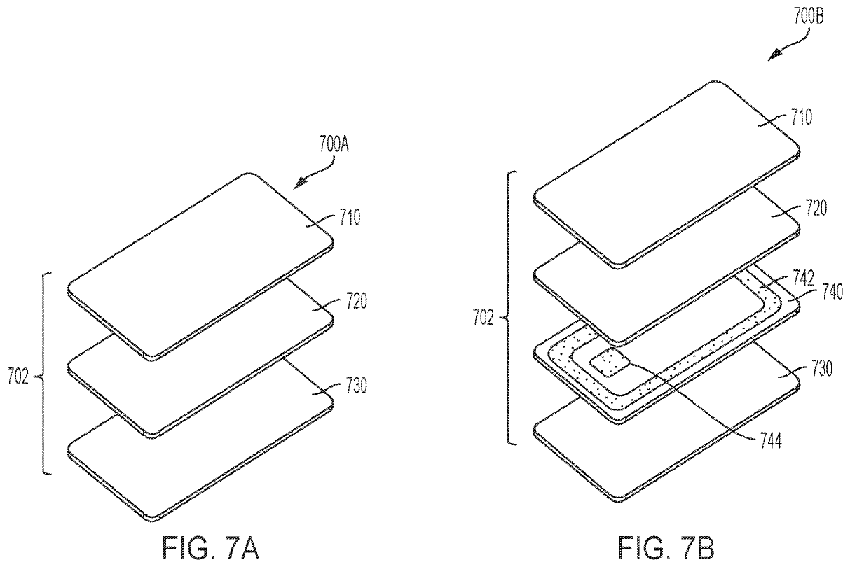

The substrate 128 can refer to any layer that forms part of the body of the payment card 100 (e.g., the card body) or the substrate 128 can refer to the entire card body of the payment card 100. For example, as described in detail below with respect to FIGS. 7A-7B, the payment card 100 can be constructed using one or more than one layer of material. Thus, in aspects where the payment card 100 includes multiple layers of material, the substrate 128 can be any one or more than one of the layers, such as, for example, all of the layers. In aspects where the payment card 100 includes only a single layer of material, the substrate can be the single layer of material. Examples of suitable materials for the substrate 128 and/or the layers thereof are described with respect to FIGS. 7A-7B.

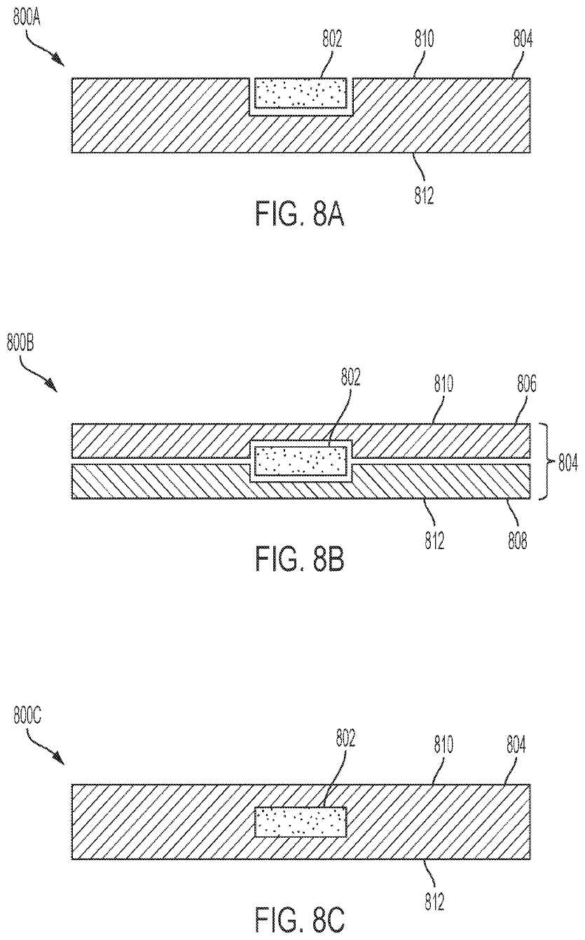

In various aspects, the magnet(s) 122 and/or the alignment magnet(s) 126 can be embedded in the substrate 128. For example, as described in detail below with respect to FIG. 8A-8C, the substrate 128 may define a first surface and a second surface opposite the first surface. The payment card 100 can be configured such that neither the magnet(s) 122 nor the alignment magnet(s) 126 protrude beyond the first surface or the second surface of the substrate 128. In one aspect, any of the magnet(s) 122 and/or the alignment magnet(s) 126 can be substantially flush with the first surface and/or the second surface of the substrate 128. Thus, the magnet(s) 122 and/or the alignment magnet(s) 126 may be visible when looking at the assembled payment card 100 (e.g., as shown in FIG. 4). In another aspect, any of the magnet(s) 122 and/or the alignment magnet(s) 126 can be embedded between the first surface and the second surface (e.g., fully embedded within the substrate 128). Thus, the magnet(s) 122 and/or the alignment magnet(s) 126 may not be visible when looking at the assembled payment card 100.

Embedding the magnet(s) 122 and/or the alignment magnet(s) 126 in the substrate 128 can allow the payment card 100 to be inserted into an access device (e.g., swiped across a magnetic stripe reader, dipped into a chip reader, etc.). For example, inserting the payment card 100 into an access device may require that a first surface and a second surface (e.g., a front surface and a back surface) of the payment card 100 be substantially flat so that the payment card 100 can be smoothly swiped across or dipped into the access device. If the magnet(s) 122 and/or the alignment magnet(s) 126 protruded beyond the first surface and or the second surface of the payment card 100, then the magnet(s) 122 and/or the alignment magnet(s) 126 could contact the access device and potentially prevent the payment card 100 from being smoothly swiped or dipped therein. In some aspects, this may prevent the payment card 100 from being fully swiped or dipped and could ultimately prevent the access device from reading information stored on the payment card 100. Thus, embedding the magnet(s) 122 and/or the alignment magnet(s) 126 in the substrate 128 can allow the payment card 100 to be being fully swiped across or dipped into an access device without causing physical interference through contact.

Still referring to FIG. 4, the magnet(s) 122 and/or the alignment magnet(s) 126 can enable the payment card 100 to be removably attached to and/or aligned with the portable electronic device 102 by magnetically coupling with components of the wireless charging system 110. For example, as indicated by the arrows 121, the magnets 122 of magnet array 120 can magnetically couple with the ferromagnetic component 106 of the wireless charging system 110. Similarly, as indicated by the arrow 123, the alignment magnets 126 of the alignment magnet array 124 can magnetically couple with the ferromagnetic alignment component 108 of the wireless charging system 110. Thus, in some aspects, the payment card 100 can be configured to reliably attach to the portable electronic device 102 by taking advantage of various ferromagnetic components included in the portable electronic device 102 as part of a wireless charging system 110.

FIGS. 5A-5B illustrate the payment card 100 aligning relative to the portable electronic device 102 based on magnetic coupling of the alignment magnet(s) 126 to the ferromagnetic alignment component 108, according to at least one aspect of the present disclosure. As explained above, the magnets 122 of the magnet array 120 can magnetically couple with the ferromagnetic component 106 to removably attach the payment card 100 to the portable electronic device 102. In some aspects, the payment card 100 may not be aligned relative to the portable electronic device 102 even after the magnets 122 of the magnet array 120 are magnetically coupled with the ferromagnetic component 106. For example, as shown in FIG. 5A, the magnets 122 of magnet array 120 are magnetically coupled with the ferromagnetic component 106 (not shown in FIG. 5A) but the various edges of the payment card 100 are not parallel with the various edges of the portable electronic device 102 and some corners of the payment card 100 are exposed. Thus, the payment card 100 is potentially susceptible to becoming inadvertently removed, for example, by an object contacting one of the exposed corners of the payment card 100.

Transitioning from FIG. 5A to FIG. 5B, as the alignment magnets 126 of the alignment magnet array 124 magnetically couple with the ferromagnetic alignment component 108, the payment card 100 is rotationally aligned with portable electronic device 102. This may cause the various edges of the payment card 100 to be parallel or substantially parallel with the various edges of the portable electronic device 102 such that the corners of the payment card 100 are not exposed. Accordingly, as a result of the alignment caused by the alignment magnet(s) 126 magnetically coupling with the ferromagnetic alignment component 108, the payment card 100 may be less susceptible to becoming inadvertently removed from the payment card 102. Furthermore, the payment card 100 may be aesthetically positioned with respect to the portable electronic device 102.

FIGS. 6A-6D respectively illustrate payment cards 600, 610, 620, and 630 including various magnet arrays. Any aspects of the payment cards 600, 610, 620, and 630 can be included in the payment card 100 described above (and vice versa). As noted above with respect to FIG. 4, the magnet(s) 122 and/or the magnet array 120 can define a linear configuration, a polygonal configuration (e.g., a polygon with 3, 4, 5, 6, 7, 8, or more than 8 sides), or a ring configuration. FIG. 6A illustrates one example of a magnet array 602 including magnets 604 that define a linear configuration. FIG. 6B illustrates one example of a magnet array 612 including magnets 614 that define a ring configuration. FIG. 6C illustrates one example of a magnet array 622 including magnets 624 that define a polygonal configuration with 4 sides. FIG. 6D illustrates one example of a magnet array 632 that includes a single magnet 634. As shown in FIGS. 6A-6D, the magnets 604, 614, 624, 634 are substantially flush with an outer surface of the respective payment card 600, 610, 620, 630. Alternatively, any one or more than one of the magnets 604, 614, 624, 634 can be wholly embedded in the respective payment card 600, 610, 620, 630.

The number, shape, and size of the magnets 604, 614, 624, 634 in the magnet arrays 602, 612, 622, 632 depicted in FIGS. 6A-6D are provided for illustrative purposes. Similarly, the depictions of the position of the magnets 604, 614, 624, 634 within the payment cards 600, 610, 620, 630 and the position of the magnets 604, 614, 624, 634 relative to each other are provided for illustrative purposes. The position of any of the magnet arrays 602, 612, 622, 632 can be shifted, rotated, and/or otherwise modified. Further, any of the magnet arrays disclosed herein (e.g., magnet arrays 602, 612, 622, 632) can include any number (any positive integer greater than or equal to one) of magnets. The magnets included in any a particular magnet array can all be the same size and shape or can have varying sizes and/or shapes. For example, the magnets included in a particular magnet array can have any combination of arcuate (e.g., arc-shaped, curve-shaped, similar to magnets 614 of FIG. 6B), square-shaped (e.g., similar to magnet 634 of FIG. 6D), rectangular-shaped (e.g., similar to magnets 604 of FIG. 6A), circle-shaped, ellipse-shaped, polygon-shaped, and/or other suitably shaped magnets. Further, the alignment magnet(s) and the alignment magnet arrays disclosed herein (e.g., alignment magnet(s) 126, alignment magnet array 124) can be configured similarly to any of the magnets and magnet arrays (e.g., magnets 604, 614, 624, 634, magnet arrays 602, 612, 622, 632) disclosed herein.

In some aspects, any the magnets disclosed herein (e.g., magnet(s) 122, alignment magnet(s) 124, magnets 604, 614, 624, 634) can be made of a magnetic material such as an neodymium-iron-boron (NdFeB), other rare earth magnetic materials, or other materials (e.g., ferromagnetic materials) that can be magnetized to create a persistent magnetic field. In some aspects, any of the magnets disclosed herein can have a monolithic structure having a single magnetic region with a magnetic polarity aligned in a direction normal to a first surface and a second surface (e.g., a front and back surface) of the payment card (e.g., payment card 100, 600, 610, 620, 630).

For example, referring again to FIG. 4, in some aspects, each of the magnets 122 can be a bar magnet that has been ground and shaped into an arcuate structure. The substrate 128 can have a first surface and a second surface opposite the first surface (e.g., a surface facing towards the portable electronic device 102 and a surface facing away from the portable electronic device 102). Each of the magnets 122 may have a magnetic orientation that is normal to the first and second surfaces of the substrate 128. In one aspect, when the payment card 100 is attached to the portable electronic device 102, the magnets 122 may have a north pole oriented in a direction facing towards the portable electronic device 102 a south pole oriented in a direction facing away from the portable electronic device 102. In another aspect, when the payment card 100 is attached to the portable electronic device 102, the magnets 122 may have a north pole that is oriented in a direction facing away from the portable electronic device 102 and a south pole oriented in a direction facing towards the portable electronic device 102. As another example, rather than having multiple magnets 122, the magnet array 120 may be formed of a single, monolithic annular magnet 122.

FIG. 7A-7B illustrate various payment cards 700A, 700B having multiple layers, according to several aspects of the present disclosure. Any aspects of the payment cards 700A, 700B can be included in the payment card 100 described above (and vice versa). As noted above with respect to FIG. 4, the payment card 100 can be constructed using one or more than one layer of material. FIG. 7A illustrates one example of a payment card 700A including a layer 710, a layer 720, and a layer 730. Each of the layers 710, 720, and 730 may be laminated or otherwise bonded together to form the card body 702. FIG. 7B illustrates one example of a payment card 700B including a layer 710, a layer 720, a layer 730, and a layer 740. Each of the layers 710, 720, 730, and 740 may be laminated or otherwise bonded together to form the card body 702. In other aspects, the payment cards 700A and 700B can have less than 3 layers (e.g., one layer or two layers) or more than four layers (e.g., five layers, six layers, seven layers, etc.) that are laminated or otherwise bonded together to form the card body 702 (not shown in FIGS. 7A-7B).

Referring still to FIG. 7A and FIG. 7B, in some aspects, the layer 710 and the layer 730 may be printed layers. For example, the layer 710 may define a first surface (e.g., front surface) of the payment card 700A, 700B and can include a graphic and/or text that is printed, etched, embedded, or otherwise formed thereon. Likewise, the layer 730 may define a second surface (e.g., back surface) that is opposite the first surface and can include a graphic and/or text that is printed, etched, embedded, or otherwise formed thereon.

Referring still to FIG. 7A and FIG. 7B, the layer 720 may be a core layer. For example the layer 720 may be configured to primarily provide structural support to the card body 702. Thus, in some aspects, the layer 720 may have a thickness that is relatively thicker than the layer 710 and/or the layer 730.

Referring now to FIG. 7B, the layer 740 may be an NFC antenna layer. For example an NFC antenna 742 may be embedded or otherwise included in the layer 740. In some aspects, an integrated chip 744 may be embedded or otherwise included in the layer 740. The NFC antenna 742 and/or the integrated chip 744 may be configured to transmit data (e.g., an account identifier, a name of an account holder, etc.) to an access device to initiate a transaction. In some aspects, rather than having a separate NFC antenna layer (e.g., layer 740), the NFC antenna 724 may be included in a core layer (e.g., the layer 730 of payment card 700A and/or 700B). In some aspects, the integrated chip may be embedded or otherwise included in one or more than one layer other than the layer 740. For example, the integrated chip 744 may be included in or otherwise be supported by the layer 710, the layer 720, and/or the layer 730.

In some aspects, the payment card 700A, 700B may include one or more than one transparent layer (not shown in FIGS. 7A-7B). For example, a transparent layer may be placed on an outer surface of the layer 710 and/or an outer surface of the layer 730. Thus, in some aspects, a first transparent layer may define a first surface (e.g., front surface) of the payment card 700A, 700B (and/or the card body 702) that protects a printed layer (e.g., the layer 710) while still allowing any graphics or text included in the printed layer to be visible. Likewise, in some aspects, a second transparent layer may define a second surface (e.g., back surface) of the payment card 700A, 700B (and/or the card body 702) that protects a printed layer (e.g., the layer 730) while still allowing any graphics or text included in the printed layer to be visible. The transparent layer(s) may include a transparent film made of, for example, polyvinyl chloride (PVC) or polyethylene terephthalate (PET). In some aspects, a magnetic stripe storing data (e.g., an account identifier, a name of an account holder, etc.) readable by an access device to initiate a transaction may be included on a transparent layer. In other aspects, a magnetic stripe storing data may be included on the layer 710, the layer 730, and/or another layer of the payment card 700A, 700B.

Any of the layers of the payment cards 700A, 700B may be constructed using a polymeric material, a metallic material, a paper material, and/or a wood material. Examples of suitable polymeric materials may include polyvinyl chloride (PVC), polyvinyl chloride acetate (PVCA), polylactic acid (PLA), acrylonitrile butadiene styrene (ABS), polyethylene terephthalate (PET), polyester, polycarbonate, polyethylene terephthalate (PET), polyethylene terephthalate glycol (PETG), polyolefin, polycarbonate, polyester, polyamide, and copolymers and/or blends of any thereof. Examples of suitable metallic materials may include stainless steel, aluminum, tungsten, gold, titanium, copper, and alloys of any thereof. Any of the layers of the payment cards 700A, 700B may be bonded together using heat and/or an appropriate adhesive such as an epoxy-, polyurethane-, and/or acrylate-based adhesive.

Referring still to FIG. 7A and FIG. 7B, in various aspects, the mass of the card body 702 can be in a range of 3 g to 25 g, such as about 3 g, 4 g, 5 g, 6 g, 7 g, 8 g, 9 g, 10 g, 11 g, 12 g, 13 g, 14 g, 15 g, 16 g, 17 g, 18 g, 19 g, 20 g, 21 g, 22 g, 23 g, 24 g, or about 25 g. In various aspects, the thickness of the card body 702 can be in a range of 0.50 mm to 1.00 mm, such as about 0.50 mm, 0.60 mm, 0.70 mm, 0.76 mm, 0.80 mm, 0.90 mm, or about 1.00 mm. In certain aspects, the mass and/or thickness of the card body 702 can be the standard mass and/or thickness for a payment card. For example, the card body 702 can be configured with a thickness required for the payment card 700A, 700B to be readily swiped or inserted into an access device without interference.

As mentioned above with respect to FIG. 4, the substrate 128 can refer to any layer that forms part of the body of the payment card 100 (e.g., the card body) or the entire body of the payment card 100. Thus, referring now to FIG. 4 and FIGS. 7A-7B, the substrate 128 can be any one or more than one of the layers 710, 720, 730, and/or 740, such as, for example, all of the layers (e.g., the entire card body 702). Any of the magnets (e.g., magnets 122, 604, 614, 624, 634, 802) and alignment magnets (e.g., alignment magnets 126, 802) disclosed herein can be embedded in any one or more than one of the layers 710, 720, 730, and/or 740.

FIG. 8A-8C respectively illustrate cross-sectional views of magnet embedding configurations 800A, 800B, and 800C, according to several aspects of the present disclosure. Each magnet embedding configuration 800A, 800B, 800C includes a magnet 802 embedded in a substrate 804. Each substrate 804 includes a first surface 810 and a second surface 812 opposite the first surface 810. Further, in each magnet embedding configuration 800A, 800B, 800C, the magnet 802 does not protrude beyond the first surface 810 or the second surface 812. In some aspects, the substrate 804 shown in any of FIGS. 8A-8C can represent the substrate 128 referenced above with respect to FIG. 4, any one or more than one of the layers 710, 720, 730, 740 referenced above with respect to FIGS. 7A-7B, and/or the card body 702 referenced above with respect to FIGS. 7A-7B. Thus, in some aspects, the substrate 804 may be comprised of one or more than one layer. The magnet 802 shown in any of FIGS. 8A-8C can represent any one of the magnets (e.g., magnets 122, 604, 614, 624, 634) and/or the alignment magnets (e.g., alignment magnets 126) disclosed herein.

Referring now to FIG. 8A, the magnet embedding configuration 800A includes a magnet 802 implanted into the substrate 804 such that the magnet 802 is substantially flush with the first surface 810. In one aspect, the substrate 804 of the magnet embedding configuration 800A can represent a card body of a payment card (e.g., the card body 702 of FIGS. 7A and/or 7B) where any individual layers included in the card body are not shown in FIG. 8A. In this aspect, the first surface 810 and the second surface 812 of the substrate 804 may represent outer surfaces of a payment card. In another aspect, the substrate 804 of the magnet embedding configuration 800A can represent one layer of a payment card (e.g., one of the layers 710, 720, 730, or 740 of FIGS. 7A and/or 7B). Accordingly, the first surface 810 and the second surface 812 of the substrate 804 may represent outer surfaces of a single layer of a payment card. The magnet 802 of the magnet embedding configuration 800A may be implanted into the substrate 804 by subtractively removing a portion of the substrate 804 to create a cavity and depositing the magnet 802 in the cavity. Subtractively removing the portion of the substrate 804 to create the cavity can include at least one of drilling, milling, laser cutting, etching, or machining the portion of the substrate 804.

Referring now to FIG. 8B, the magnet embedding configuration 800B includes a magnet 802 implanted into the substrate 804 such that the magnet is completely embedded in the substrate 804. Further, the substrate 804 of the magnet embedding configuration 800B includes a first layer 806 and a second layer 808. Each of the first layer 806 and the second layer 808 can represent one or more than one layer of a card body of a payment card (e.g., one or more than one of the layers 710, 720, 730, 740 of the card body 702 of FIGS. 7A and/or 7B). For example, referring to FIGS. 7B and 8B, the first layer 806 may represent the layer 720 of payment card 700B and the second layer 808 may represent the layer 740 of the payment card 700B. As another example, still referring to FIGS. 7B and 8B, the first layer 806 may represent the layers 710 and 720 of payment card 700B and the second layer 808 may represent the layers 740 and 730 of the payment card 700B such that the substrate 804 represents the entire card body 702 of payment card 700B. Referring again to FIG. 8B, the magnet 802 of the magnet embedding configuration 800B may be implanted into the substrate 804 by subtractively removing a portion of the first layer 806 to create a first cavity, subtractively removing a portion of the second layer 808 to create a second cavity, depositing the magnet 802 into at least one of the first cavity or the second cavity, and placing the first layer 806 and the second layer 808 together such that the magnet 802 spans the first cavity and the second cavity. Subtractively removing the portion of the first layer 806 to create the first cavity and/or subtractively removing the portion of the second layer 808 to create the second cavity can include at least one of drilling, milling, laser cutting, etching, or machining the portion of the first layer 806 and/or the portion of the second layer 808.

Referring now to FIG. 8C, the magnet embedding configuration 800C includes a magnet 802 that is molded (e.g., co-molded, insert molded) into the substrate 804. In one aspect, the substrate 804 of the magnet embedding configuration 800C can represent one layer of a payment card (e.g., one of the layers 710, 720, 730, or 740 of FIGS. 7A and/or 7B). Accordingly, the first surface 810 and the second surface 812 of substrate 804 may represent outer surfaces of a single layer of a payment card. In another aspect, the substrate 804 of the magnet embedding configuration 800C can represent a card body of a payment card. The magnet 802 of the magnet embedding configuration 800C may be molded into the substrate 804 by placing the magnet 802 into a cavity of a mold and injecting substrate material into the mold and around the magnet 802. In aspects where the substrate material is a polymer material (e.g., a thermoplastic material), molding the magnet 802 can further include curing the substrate material to form the substrate 804 (e.g., to form a layer of a payment card, to form a card body of a payment card). In aspects where the substrate material is a metallic material (e.g., a liquid metallic material, powdered metallic material), molding the magnet 802 can further include hardening (e.g., cooling, sintering) the substrate material to form the substrate 804 (e.g., to form a layer of a payment card, to form a card body of a payment card). In the magnet embedding configuration 800C depicted in FIG. 8C, the magnet 802 is fully embedded in the substrate 804. In other aspects, the magnet 802 of the magnet embedding configuration 800C may be substantially flush with the first surface 810 of the substrate 804 (e.g., similar to the magnet 802 of the magnet embedding configuration 800A depicted in FIG. 8A).

Examples of the devices, systems, and methods according to various aspects of the present disclosure are provided below in the following numbered clauses. An aspect of any of the devices(s), method(s) and/or system(s) may include any one or more than one, and any combination of, the numbered clauses described below.
Clause 1. A card removably attachable to a portable electronic device including a charging coil, a ferromagnetic component disposed about the charging coil, and a ferromagnetic alignment component, the card comprising: a substrate; and a magnet embedded in the substrate to magnetically couple to the ferromagnetic component disposed about the charging coil.
Clause 2. The card of Clause 2, wherein the card further comprises: an alignment magnet embedded in the substrate to magnetically couple to the ferromagnetic alignment component to align the card relative to the portable electronic device.
Clause 3. The card of any of Clauses 1-2, wherein the substrate defines a first surface and a second surface opposite the first surface, and wherein the magnet and the alignment magnet are embedded between the first surface and the second surface.
Clause 4. The card of any of Clauses 1-3, wherein the substrate comprises at least one of a magnetic stripe, an integrated chip, or a near field communication (NFC) antenna.
Clause 5. The card of any of Clauses 1-4, wherein the magnet comprises a magnet array.
Clause 6. The card of any of Clauses 1-5, wherein the magnet array defines a ring.
Clause 7. The card of any of Clauses 1-5, wherein the magnet array defines a linear configuration.
Clause 8. The card of any of Clauses 1-5, wherein the magnet array defines a polygonal configuration.
Clause 9. The card of any of Clauses 1-8, wherein the substrate comprises a mass in a range of 3 g to 25 g.
Clause 10. The card of Clauses 1-9, wherein the substrate comprises at least one of a polymeric material or a metallic material.
Clause 11. The card of Clauses 1-10, wherein the magnet defines a profile that compliments the ferromagnetic component disposed about the charging coil of the portable electronic device.
Clause 12. The card of Clauses 1-11, wherein the magnet is fully embedded within the substrate.
Clause 13. A card removably attachable to a portable electronic device including a charging coil, a ferromagnetic component disposed about the charging coil, and a ferromagnetic alignment component, the card comprising: a card body comprising a first printed layer, a second printed layer, and a core layer between the first printed layer and the second printed layer; and a magnet embedded in the card body to magnetically couple to the ferromagnetic component disposed about the charging coil.
Clause 14. The card of Clause 13, wherein the card further comprises: an alignment magnet embedded in the card body to magnetically couple to the ferromagnetic alignment component to align the card relative to the portable electronic device.
Clause 15. The card of any of Clauses 13-14, wherein the magnet is embedded between the first printed layer and the second printed layer.
Clause 16. The card of any of Clauses 13-15, wherein the magnet is molded in the core layer.
Clause 17. The card of any of Clauses 13-15, wherein the magnet is embedded in a cavity formed in the core layer.
Clause 18. The card of any of Clauses 13-14, wherein the magnet is embedded in a cavity formed in the first printed layer and the core layer.
Clause 19. The card of any of Clauses 13-15, wherein the card body further comprises a near field communication (NFC) antenna layer between the first printed layer and the second printed layer, and wherein the magnet is embedded in the NFC antenna layer.
Clause 20. The card of any of Clauses 13-19, wherein the magnet comprises a magnet array that defines at least one of a ring, a linear configuration, or a polygonal configuration.
Clause 21. The card of any of Clauses 1-20, wherein the card is at least one of a payment card, an identification card, a driver's license card, a memory card, an access card, a membership card, a loyalty card, a passport card, or an insurance card.

Further, it is understood that any one or more of the following-described forms, expressions of forms, examples, can be combined with any one or more of the other following-described forms, expressions of forms, and examples.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

The term “substantially”, “about”, or “approximately” as used in the present disclosure, unless otherwise specified, means an acceptable error for a particular value as determined by one of ordinary skill in the art, which depends in part on how the value is measured or determined. In certain aspects, the term “substantially”, “about”, or “approximately” means within 1, 2, 3, or 4 standard deviations. In certain aspects, the term “substantially”, “about”, or “approximately” means within 50%, 20%, 15%, 10%, 9%, 8%, 7%, 6%, 5%, 4%, 3%, 2%, 1%, 0.5%, or 0.05% of a given value or range.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.” With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect.

Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A card removably attachable to a portable electronic device including a charging coil, a ferromagnetic component disposed about the charging coil, and a ferromagnetic alignment component, the card comprising:
a substrate; and
a magnet embedded in the substrate to magnetically couple to the ferromagnetic component disposed about the charging coil.

2. The card of claim 1, wherein the card further comprises:
an alignment magnet embedded in the substrate to magnetically couple to the ferromagnetic alignment component to align the card relative to the portable electronic device.

3. The card of claim 2, wherein the substrate defines a first surface and a second surface opposite the first surface, and wherein the magnet and the alignment magnet are embedded between the first surface and the second surface.

4. The card of claim 1, wherein the substrate comprises at least one of a magnetic stripe, an integrated chip, or a near field communication (NFC) antenna.

5. The card of claim 1, wherein the magnet comprises a magnet array.

6. The card of claim 5, wherein the magnet array defines a ring.

7. The card of claim 5, wherein the magnet array defines a linear configuration.

8. The card of claim 5, wherein the magnet array defines a polygonal configuration.

9. The card of claim 1, wherein the substrate comprises a mass in a range of 3 g to 25 g.

10. The card of claim 1, wherein the substrate comprises at least one of a polymeric material or a metallic material.

11. The card of claim 1, wherein the magnet defines a profile that compliments the ferromagnetic component disposed about the charging coil of the portable electronic device.

12. The card of claim 1, wherein the magnet is fully embedded within the substrate.

13. A card removably attachable to a portable electronic device including a charging coil, a ferromagnetic component disposed about the charging coil, and a ferromagnetic alignment component, the card comprising:
a card body comprising a first printed layer, a second printed layer, and a core layer between the first printed layer and the second printed layer; and
a magnet embedded in the card body to magnetically couple to the ferromagnetic component disposed about the charging coil.

14. The card of claim 13, wherein the card further comprises:
an alignment magnet embedded in the card body to magnetically couple to the ferromagnetic alignment component to align the card relative to the portable electronic device.

15. The card of claim 13, wherein the magnet is embedded between the first printed layer and the second printed layer.

16. The card of claim 15, wherein the magnet is molded in the core layer.

17. The card of claim 15, wherein the magnet is embedded in a cavity formed in the core layer.

18. The card of claim 13, wherein the magnet is embedded in a cavity formed in the first printed layer and the core layer.

19. The card of claim 13, wherein the card body further comprises a near field communication (NFC) antenna layer between the first printed layer and the second printed layer, and wherein the magnet is embedded in the NFC antenna layer.

20. The card of claim 13, wherein the magnet comprises a magnet array that defines at least one of a ring, a linear configuration, or a polygonal configuration.
